(19) United States
(12) Patent Application Publication
(10) Pub. No.: US 2026/0190046 A1
(43) Pub. Date: Jul. 2, 2026

(54) METHOD AND DEVICE FOR MONITORING CHANNEL IN SIDELINK COMMUNICATION

(71) Applicants: HYUNDAI MOTOR COMPANY, Seoul (KR); KIA CORPORATION, Seoul (KR); GACHON UNIVERSITY INDUSTRY-ACADEMIC COOPERATION FOUNDATION, Seongnam-si (KR)

(72) Inventors: Ui Hyun Hong, Hwaseong-si (KR); Hyuk Min Son, Seoul (KR)

(73) Assignees: HYUNDAI MOTOR COMPANY, Seoul (KR); KIA CORPORATION, Seoul (KR); GACHON UNIVERSITY INDUSTRY-ACADEMIC COOPERATION FOUNDATION, Seongnam-si (KR)

(21) Appl. No.: 18/844,916

(22) PCT Filed: May 10, 2023
(86) PCT No.: PCT/KR2023/006386

§ 371 Date: Sep. 6, 2024

(30) Foreign Application Priority Data
May 16, 2022 (KR) 10-2022-0059702

(51) Int. Cl. H04W 56/00; H04B 7/06; H04W 24/10; H04W 72/25; H04W 92/18

(52) U.S. Cl. CPC H04W 56/0015; H04B 7/0696; H04W 24/10; H04W 72/25; H04W 92/18

(57) ABSTRACT

A method and a device for monitoring a channel in sidelink communication are disclosed. The method of a first UE comprises the steps of: receiving, from a second UE, one or more S-SSBs by using a plurality of beams; determining, on the basis of measurement results of the one or more S-SSBs, two or more beams used in SL communication between the first UE and the second UE; and performing a first PSCCH monitoring operation on the second UE by using an omni-beam from among the two or more beams.

### TECHNICAL FIELD

The present disclosure relates to a sidelink communication technique, and more particularly, to a technique for signal/channel monitoring operations.

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, sidelink (SL) communication may be performed in high-frequency bands, including an FR2 band. In this case, SL communication may be performed after a beam pairing operation (e.g., initial beam pairing operation) between terminals is completed. A receiving terminal may perform beam pairing operations with multiple transmitting terminals. After the beam pairing operations are completed, the receiving terminal may perform physical sidelink control channel (PSCCH) reception operations for the multiple transmitting terminals. If the receiving terminal uses different beams to receive signals/channels from the multiple transmitting terminals, respectively, constraints on the PSCCH monitoring operations may occur. For example, if reception operations using only one beam are possible in a specific time-frequency resource, the receiving terminal can only perform a PSCCH monitoring operation for a specific transmitting terminal in that specific time-frequency resource.

### DISCLOSURE

### Technical Problem

The present disclosure is directed to providing a method and an apparatus for signal/channel monitoring operations in sidelink communication.

### Technical Solution

A method of a first user equipment (UE), according to a first exemplary embodiment of the present disclosure for achieving the above-described objective, may comprise: receiving one or more sidelink-synchronization signal blocks (S-SSBs) from a second UE using a plurality of beams; determining two or more beams used in sidelink (SL) communication between the first UE and the second UE based on a measurement result of the one or more S-SSBs; and performing a first physical sidelink control channel (PSCCH) monitoring operation for the second UE using an omni-beam among the two or more beams, wherein the two or more beams belong to the plurality of beams.

The method may further comprise: in response to a failure of the first PSCCH monitoring operation, performing a second PSCCH monitoring operation for the second UE using a directional beam among the two or more beams.

When the measurement result is greater than or equal to a measurement threshold, the first PSCCH monitoring operation may be performed preferentially using the omni-beam.

When a distance between a first location of the first UE and a second location of the second UE is within a reference distance, the first PSCCH monitoring operation may be performed preferentially using the omni-beam.

Information on the second location of the second UE may be received from the second UE, and information on the reference distance may be received from at least one of the second UE or a base station.

A method of a first UE, according to a second exemplary embodiment of the present disclosure for achieving the above-described objective, may comprise: performing an initial access operation with one or more second UEs to determine a plurality of reception beams for the first UE; configuring a first reception beam set including the plurality of reception beams; and performing a first physical sidelink control channel (PSCCH) monitoring operation for the one or more second UEs using one or more reception beams belonging to the first reception beam set.

When the one or more reception beams are a plurality of reception beams, the first PSCCH monitoring operation may be performed using the plurality of reception beams sequentially.

When the one or more reception beams include a first reception beam and a second reception beam, and a number of second UEs having beams paired with the first reception beam is greater than a number of second UEs having beams paired with the second reception beam, a number of times the first PSCCH monitoring operation using the first reception beam is performed may be greater than a number of times the first PSCCH monitoring operation using the second reception beam is performed.

A maximum number of reception beams used for the first PSCCH monitoring operation within one PSCCH monitoring period may be set to the first UE through signaling, and a number of the one or more reception beams may be less than or equal to the maximum number.

When a maximum number of reception beams used for the first PSCCH monitoring operation within one PSCCH monitoring period is set to the first UE through signaling, and a number of the plurality of reception beams included in the first reception beam set exceeds the maximum number, the first PSCCH monitoring operation may be performed using the one or more reception beams with higher priority among the plurality of reception beams.

The method may further comprise: configuring a second reception beam set including the one or more reception beams with a higher priority, wherein the first PSCCH monitoring operation may be performed using the second reception beam set instead of the first reception beam set.

Priorities of the plurality of reception beams included in the first reception beam set may be determined based on a measurement result of sidelink-synchronization signal blocks (S-SSBs) received in the initial access operation.

The method may further comprise: in response to no PSCCH being received in the first PSCCH monitoring operation, reconfiguring the first reception beam set including at least one reception beam excluding the one or more reception beams from the plurality of reception beams.

A method of a first UE, according to a third exemplary embodiment of the present disclosure for achieving the above-described objective, may comprise: configuring a first reception beam set; configuring a second reception beam set; and performing a first physical sidelink control channel (PSCCH) monitoring operation using one reception beam set with a higher priority among the first reception beam set and the second reception beam set, wherein each of the first reception beam set and the second reception beam set includes one or more reception beams.

The method may further comprise: in response to a failure of the first PSCCH monitoring operation, performing a second PSCCH monitoring operation using another reception beam set with a lower priority than the one reception beam set among the first reception beam set and the second reception beam set.

The method may further comprise: in response to a number of beams included in the first reception beam set being less than a number of beams included in the second reception beam set, determining the first reception beam set as the one reception beam set with a higher priority.

The method may further comprise: in response to the first reception beam set including an omni-beam and the second reception beam set including no omni-beam, determining the first reception beam set as the one reception beam set with a higher priority.

The method may further comprise: in response to the second reception beam set being configured more recently than the first reception beam set, determining the second reception beam set as the one reception beam set with a higher priority.

### Advantageous Effects

According to the present disclosure, a receiving terminal can determine one or more reception beams in an initial access operation with a transmitting terminal and perform a PSCCH monitoring operation using the reception beam(s) with a high priority among the one or more reception beams. Further, the receiving terminal may configure multiple reception beam sets and perform the PSCCH monitoring operation using a reception beam set with a high priority among the multiple reception beam sets. According to these operations, the performance of PSCCH monitoring operations can be improved.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a conceptual diagram illustrating a first exemplary embodiment of a PSCCH monitoring operation.

FIG. 10 is a conceptual diagram illustrating a second exemplary embodiment of a PSCCH monitoring operation.

FIG. 11 is a conceptual diagram illustrating a third exemplary embodiment of a PSCCH monitoring operation.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

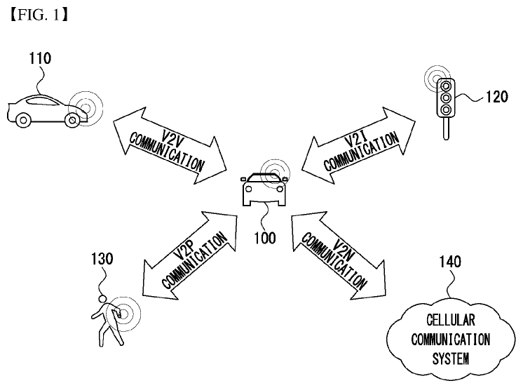

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications’. Here, the communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink communication technologies (e.g., Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In this case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3GPP standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

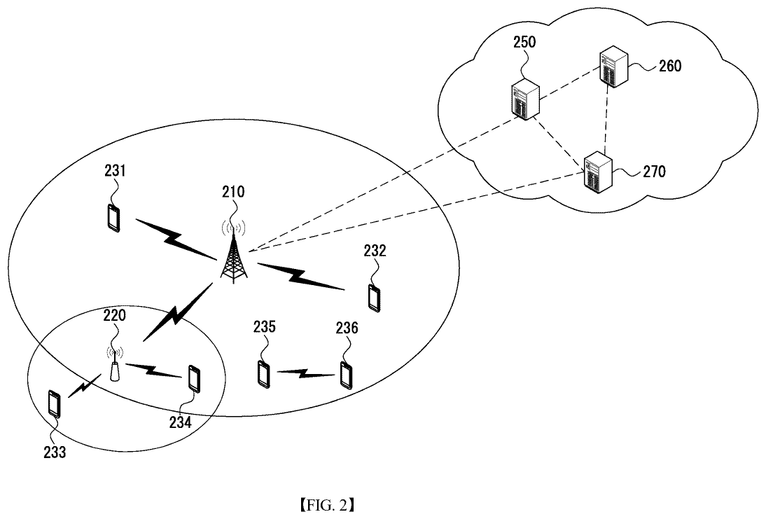

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slices configured in the core network.

The communication nodes (e.g., base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) constituting the communication system may be configured as follows.

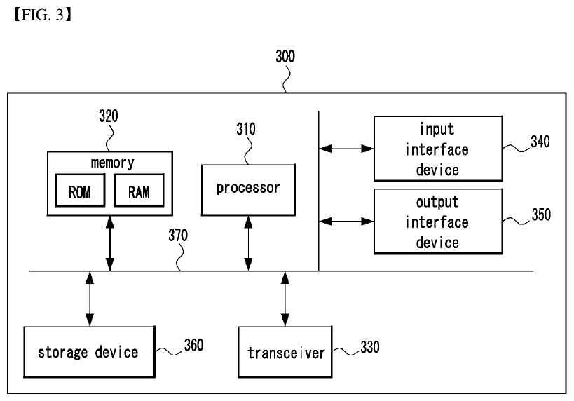

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, etc.), coordinated multipoint (CoMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

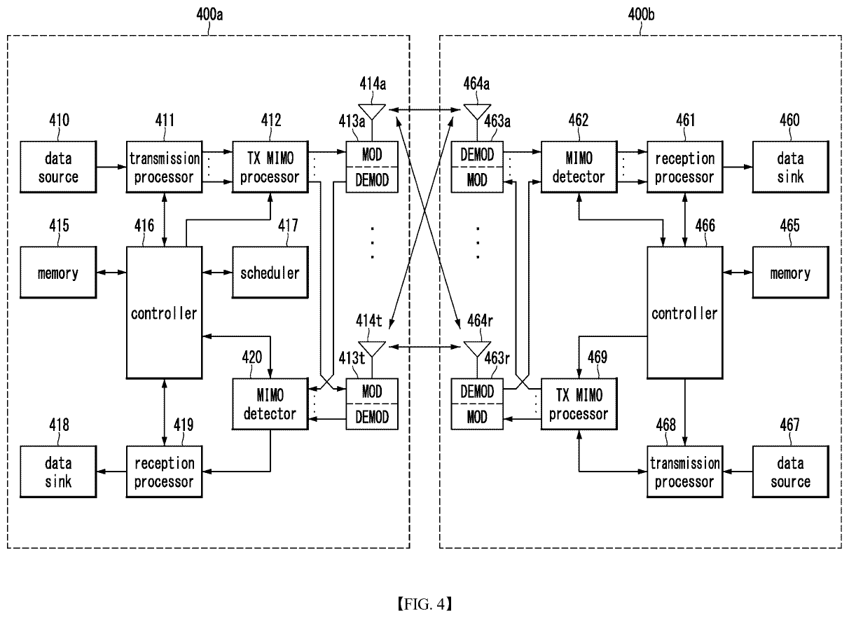

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

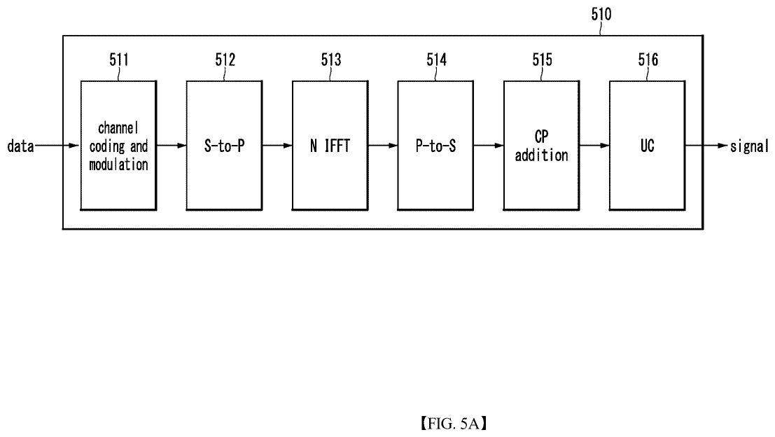

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | Position | Position |
| Scenario | of UE 235 | of UE 236 |
| A | Out of coverage of | Out of coverage of |
| | base station 210 | base station 210 |
| B | In coverage of base | Out of coverage of |
| | station 210 | base station 210 |
| C | In coverage of base | In coverage of base |
| | station 210 | station 210 |
| D | In coverage of base | In coverage of other |
| | station 210 | base station |

Meanwhile, a user plane protocol stack of the UEs (e.g., the UEs 235 and 236) performing sidelink communications may be configured as follows.

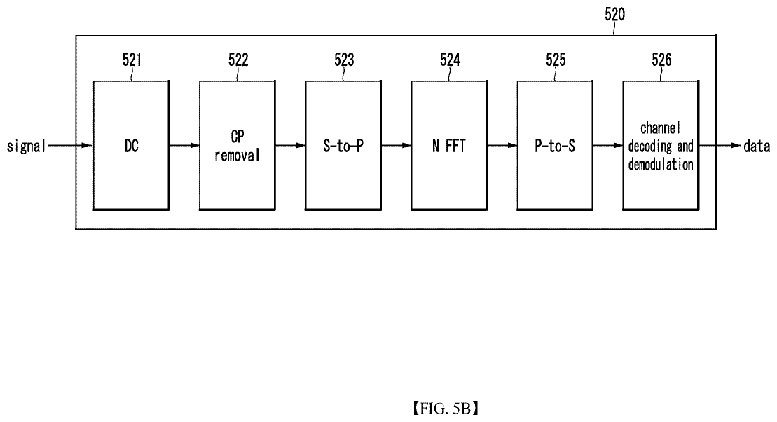

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

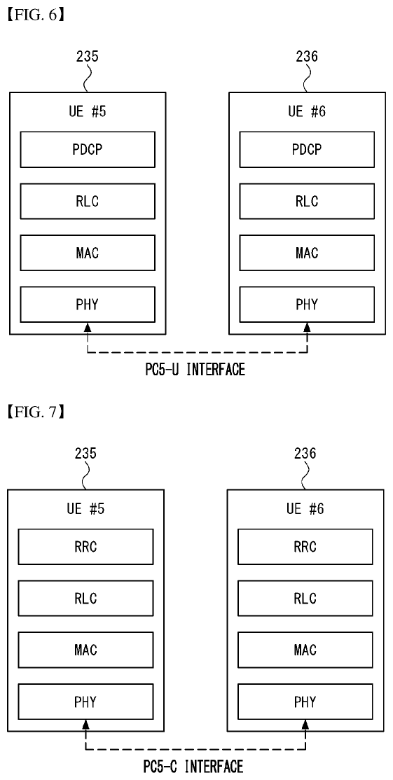

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink TM | Description |
|---|---|
| 1 | Transmission using resources scheduled |
| | by base station |
| 2 | UE autonomous transmission without |
| | scheduling of base station |
| 3 | Transmission using resources scheduled |
| | by base station in V2X communications |
| 4 | UE autonomous transmission without scheduling |
| | of base station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e., sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, sidelink (SL) communication may be performed in an FR1 band and/or FR2 band. A terminal may receive a synchronization signal from a base station, satellite, or another terminal, and may acquire synchronization based on the synchronization signal. In SL communication, a terminal transmitting a synchronization signal may be a transmitting terminal or another terminal. In the present disclosure, a transmitting terminal may refer to a terminal that transmits a PSCCH and/or PSSCH, and a receiving terminal may refer to a terminal that receives a PSCCH and/or PSSCH. The transmitting terminal may be referred to as a first terminal, and in this case, the receiving terminal may be referred to as a second terminal. Alternatively, the transmitting terminal may be referred to as a second terminal, and in this case, the receiving terminal may be referred to as a first terminal.

SL communication may be performed in high frequency bands including an FR2 band. In this case, SL communication may be performed after a beam pairing operation between terminals is completed. In the present disclosure, a beam pairing operation may mean an initial beam pairing operation. A receiving terminal may perform beam pairing operations with a plurality of transmitting terminals. After the beam pairing operations are completed, the receiving terminal may perform PSCCH reception operations for the plurality of transmitting terminals. If the receiving terminal uses different beams to receive signals/channels from the plurality of transmitting terminals, constraints on PSCCH monitoring operations may occur. For example, if a reception operation using only one beam is possible in a specific time-frequency resource, the receiving terminal can only perform a PSCCH monitoring operation for a specific transmitting terminal in the specific time-frequency resource. In the present disclosure, ‘time-frequency resource’ may include at least one of ‘time resource’ or ‘frequency resource’.

As the number of reception beams that the receiving terminal operates for PSCCH monitoring operations increases, a resource region (e.g., the number of resources) in which a PSCCH monitoring operation for one transmitting terminal is performed may be reduced. In order for the receiving terminal to receive a PSCCH (e.g., SCI), the transmitting terminal may transmit the PSCCH in the resource region where the receiving terminal performs the PSCCH monitoring operation. If the number of reception beams of the receiving terminal is large, a candidate PSCCH transmission resource region may be reduced. A reception beam may refer to a reception direction. A reception beam of the receiving terminal may be paired with a transmission beam of the transmitting terminal. In other words, a beam pair may include a transmission beam of the transmitting terminal and a reception beam of the receiving terminal.

The transmitting terminal may not know information on the resource region in which the receiving terminal performs the PSCCH monitoring operation. In this case, the transmitting terminal may transmit the PSCCH in an arbitrary resource region, and the receiving terminal may not receive the PSCCH of the transmitting terminal. There is a need for PSCCH monitoring methods for resolving the above-described problem.

The transmitting terminal may transmit sidelink(S)-synchronization signal blocks (SSBs) using different beams. In other words, the S-SSBs may be transmitted using a beam sweeping scheme. The S-SSBs may be transmitted within a preconfigured transmission resource region. The beam sweeping operation for S-SSBs may be the same or similar to a beam sweeping operation for SSBs.

The receiving terminal may perform S-SSB reception operations using different beams. The receiving terminal may receive S-SSB(s), obtain synchronization signal(s) and PSBCH(s) included in the S-SSB(s), and based on the synchronization signal(s) and/or PSBCH(s) (e.g., information included in the PSBCH(s)), the receiving terminal may perform beam pairing operations with one or more transmitting terminals. In the beam pairing operation, information on beams available for transmission and reception of signals/channels between the transmitting terminal and the receiving terminal may be exchanged. In the present disclosure, ‘signal/channel’ may include at least one of ‘signal’ or ‘channel’. The S-SSB reception operation and/or beam pairing operation may be included in an initial access operation.

The receiving terminal may select a specific beam (e.g., optimal beam, preferred beam) based on the S-SSB(s) received from the transmitting terminal, and transmit information on the specific beam to the transmitting terminal. The transmitting terminal may receive information on the specific beam from the receiving terminal, and may transmit a signal/channel (e.g., data) to the receiving terminal using the specific beam. In the present disclosure, a beam may be interpreted as a transmission beam or a reception beam depending on a context.

The receiving terminal may complete the beam pairing operations with one or more transmitting terminals, and then perform PSCCH monitoring operations using beam(s) determined by the beam pairing operation. The transmitting terminal may be a terminal that wishes to transmit data to the receiving terminal, a terminal that has transmitted synchronization information (e.g., S-SSB) to the receiving terminal, and/or a terminal that wishes to transmit data to another receiving terminal. The receiving terminal may acquire synchronization from a specific synchronization source and perform the PSCCH monitoring operation for the transmitting terminal other than the specific synchronization source. Exemplary embodiments below may be applied to the PSCCH monitoring operation. The receiving terminal may perform the PSCCH monitoring operation using n or less beams. n may be a natural number.

[Method 1] The receiving terminal may perform a PSCCH monitoring operation using beams including an omni-beam. The number of beams used by the receiving terminal may be n or less. n may be a natural number.

The transmitting terminal(s) may transmit S-SSB(s). The S-SSB may be referred to as a synchronization signal. The S-SSB(s) may be transmitted in a beam sweeping scheme. The receiving terminal may receive S-SSB(s) using beam(s). The beam(s) used for reception of the S-SSB(s) may include an omni-beam. For example, the receiving terminal may receive the S-SSB(s) using directional beam(s) and the omni-beam. The receiving terminal may determine reception beam(s) to be used in SL communication with the transmitting terminal by performing the S-SSB reception operation. In other words, the reception beam(s) to be used in SL communication between the receiving terminal and the transmitting terminal may be determined based on a measurement result of the S-SSB(s). The reception beam(s) determined by the receiving terminal may include the omni-beam and at least one directional beam. When the S-SSB(s) are received (e.g., when SL synchronization is acquired), the receiving terminal may perform the PSCCH monitoring operation using the omni-beam preferentially. If the PSCCH monitoring operation using the omni-beam fails, the receiving terminal may perform the PSCCH monitoring operation using another beam (e.g., directional beam). The failure of the PSCCH monitoring operation may mean that no PSSCH is received in the PSCCH monitoring operation.

If a measurement result of an S-SSB (e.g., S-SSB received through the omni-beam) or a measurement result of a signal/channel included in the S-SSB is greater than or equal to a measurement threshold, the receiving terminal may perform the PSCCH monitoring operation by preferentially using the omni-beam. The measurement result may indicate a reference signal received power (RSRP), reference signal received quality (RSRQ), and/or received signal strength indicator (RSSI). The signal/channel included in the S-SSB may be a primary synchronization signal (PSS), secondary synchronization signal (SSS), PSBCH, and/or PSBCH DMRS. The PSBCH DMRS may refer to a DMRS used for demodulation of the PSBCH. The measurement threshold may be set to the receiving terminal through signaling. In other words, the base station and/or the transmitting terminal may inform the terminal of the measurement threshold through signaling. The signaling may be at least one of higher layer signaling, MAC signaling, or PHY signaling. The higher layer signaling may mean signaling of an MIB (e.g., sidelink(S)-MIB), signaling of an SIB (e.g., sidelink(S)-SIB), and/or signaling of an RRC message.

The transmitting terminal may transmit an S-SSB including information on a location of the transmitting terminal. Alternatively, the transmitting terminal may transmit information on a location of the transmitting terminal to the receiving terminal through signaling. The receiving terminal may identify the information on the location of the transmitting terminal through the S-SSB and/or another signaling. The receiving terminal may compare its location with the location of the transmitting terminal. If a distance between the location of the receiving terminal and the location of the transmitting terminal is within a reference distance, the receiving terminal may perform the PSCCH monitoring operation by preferentially using the omni-beam. The reference distance may mean a distance at which the receiving terminal is able to receive a PSCCH using the omni-beam. The base station and/or the transmitting terminal may transmit information on the reference distance to the receiving terminal through signaling. Alternatively, the receiving terminal may determine the reference distance directly.

Even if the receiving terminal receives S-SSB(s) using beam(s) not including the omni-beam in the initial access operation, the receiving terminal may perform the PSCCH monitoring operation by using preferentially using the omni-beam based on a result of comparison between the distance between the locations of the receiving and transmitting terminals and the reference distance. For example, the receiving terminal may receive S-SSB(s) from the transmitting terminal using a directional beam, and if the distance between the locations of the receiving and transmitting terminals is within the reference distance, the receiving terminal may perform the PSCCH monitoring operation for the transmitting terminal using the omni-beam.

As the number of transmitting terminals applicable for PSCCH monitoring operations based on the omni-beam increases, the receiving terminal may simultaneously perform PSCCH monitoring operations for many transmitting terminals within a candidate resource region capable of PSCCH transmission. The candidate resource region capable of PSCCH transmission may refer to a candidate PSCCH transmission region and/or a PSCCH monitoring resource region. The PSCCH monitoring operation based on the omni-beam may refer to a PSCCH monitoring operation using the omni-beam. A PSCCH monitoring operation based on a directional beam may refer to a PSCCH monitoring operation using the directional beam. In the present disclosure, a PSCCH monitoring operation may be interpreted as the omni-beam-based PSCCH monitoring operation or directional beam-based PSCCH monitoring operation depending on a context. When the receiving terminal performs PSCCH monitoring operations for specific transmitting terminal(s) using a specific beam, a PSCCH monitoring operation for other transmitting terminal(s) using the specific beam may not be possible in the candidate PSCCH transmission region. The PSCCH monitoring operation for other transmitting terminal(s) may be performed using another beam instead of the specific beam.

[Method 2] The receiving terminal may receive S-SSBs from a plurality of transmitting terminals, determine reception beam(s) based on the S-SSBs, and use the reception beam(s) to perform a PSCCH monitoring operation.

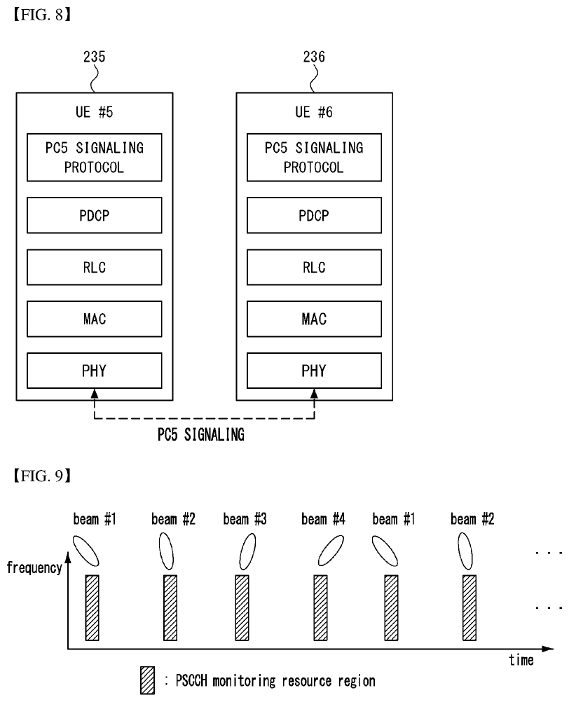

FIG. 9 is a conceptual diagram illustrating a first exemplary embodiment of a PSCCH monitoring operation.

As shown in FIG. 9, a receiving terminal may determine reception beam(s) for transmitting terminal(s) by performing an initial access operation (e.g., S-SSB reception operation and/or beam pairing operation), and may configure the reception beam(s) as a reception beam set for PSCCH monitoring. The reception beam(s) may be determined based on a measurement result of S-SSB(s) (e.g., synchronization signal(s)). The receiving terminal may perform PSCCH monitoring operations using the beam(s) belonging to the reception beam set. The reception beam set may include one or more beams. The reception beam set may include directional beam(s) and an omni-beam. For example, the reception beam set may include a beam #1, beam #2, beam #3, and beam #4. Beams belonging to the same reception beam set may have the same beam width. Alternatively, beams belonging to the same reception beam set may have different beam widths. The transmitting terminal(s) may transmit PSCCH(s) (e.g., SCI(s)) in a PSCCH monitoring resource region. The receiving terminal may perform the PSCCH monitoring operation in the PSCCH monitoring resource region by sequentially using the beams belonging to the reception beam set. For example, the receiving terminal may perform the PSCCH monitoring operation in an order of ‘beam #1→beam #2→beam #3→beam #4’.

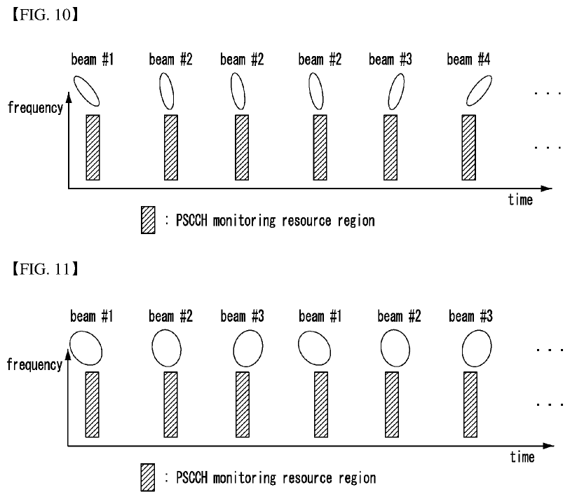

FIG. 10 is a conceptual diagram illustrating a second exemplary embodiment of a PSCCH monitoring operation.

As shown in FIG. 10, a receiving terminal may determine reception beam(s) for transmitting terminal(s) by performing an initial access operation (e.g., S-SSB reception operation and/or beam pairing operation), and may configure the reception beam(s) as a reception beam set for PSCCH monitoring. The receiving terminal may perform PSCCH monitoring operations using the beam(s) belonging to the reception beam set. The reception beam set may include one or more beams. For example, the reception beam set may include a beam #1, beam #2, beam #3, and beam #4. Beams belonging to the same reception beam set may have the same beam width. Alternatively, beams belonging to the same reception beam set may have different beam widths. The transmitting terminal(s) may transmit PSCCH(s) (e.g., SCI(s)) in a PSCCH monitoring resource region.

The receiving terminal may perform the PSCCH monitoring operation by using a specific beam (e.g., beam #2) more frequently among the beams belonging to the reception beam set. For example, the PSCCH monitoring operation using the beam #1 may be performed once in a specific time interval, the PSCCH monitoring operation using the beam #2 may be performed three times in the specific time interval, the PSCCH monitoring operation using the beam #3 may be performed once in the specific time interval, and the PSCCH monitoring operation using the beam #4 may be performed once in the specific time interval. If the number of transmitting terminals having beams paired with the beam #2 of the receiving terminal is large, the number of times the PSCCH monitoring operation is performed using the beam #2 may increase.

In the exemplary embodiments of FIGS. 9 and 10, a mapping order and a mapping ratio between the beams and the PSCCH monitoring resource region may be configured variously. The receiving terminal may perform the PSCCH monitoring operation according to the exemplary embodiment of FIG. 9 and/or FIG. 10. In this case, the transmitting terminal(s) may not know a beam (e.g., reception beam) used by the receiving terminal at a specific time (e.g., specific PSCCH monitoring resource region). To solve the above-described problem, methods for the transmitting terminal(s) to efficiently perform PSCCH transmission may be needed. A time required for the receiving terminal to complete the PSCCH monitoring operation using all or some beams belonging to the reception beam set may be set as a PSCCH monitoring period. The receiving terminal may perform the PSCCH monitoring operation using all or some beams belonging to the reception beam set within the PSCCH monitoring period.

The PSCCH monitoring period may refer to a valid time interval within a PSCCH monitoring span. The PSCCH monitoring period may be set by a timer. The timer may operate at a start time of the PSCCH monitoring period, and the receiving terminal may perform the PSCCH monitoring operation while the timer operates. When the timer expires, the receiving terminal may stop the PSCCH monitoring operation. If no PSCCH is not received within the PSCCH monitoring period, the timer may expire. If the timer expires without receiving a PSCCH, the receiving terminal may immediately restart the PSCCH monitoring period or timer. In other words, the current PSCCH monitoring period may be continuous with the previous PSCCH monitoring period in the time domain. Alternatively, if the timer expires without receiving a PSCCH, the receiving terminal may restart the PSCCH monitoring period or timer after a certain time offset. In other words, the current PSCCH monitoring period may not be continuous with the previous PSCCH monitoring period in the time domain.

The PSCCH monitoring period, time-frequency resources for PSCCH monitoring within the PSCCH monitoring period, and/or time offset therefor may be configured cell-specifically, UE-specifically, SL-specifically, or resource pool (RP)-specifically. The PSCCH monitoring period, time-frequency resources for PSCCH monitoring within the PSCCH monitoring period, and/or time offset therefor may be configured to the terminal(s) through signaling. The signaling may refer to signaling between a base station and the terminal and/or signaling between terminals.

The number of beams that the receiving terminal is able to use for the PSCCH monitoring operation within one PSCCH monitoring period may be limited. The limited number (e.g., maximum number) may be set to the terminal(s) through signaling. When the number of beams belonging to one reception beam set is greater than the limited number, the receiving terminal may select one or more beams among the beams belonging to one reception beam set based on priorities, and use the selected one or more beams to perform the PSCCH monitoring operation. In other words, the receiving terminal may select one or more beams with higher priorities among the beams belonging to one reception beam set. The number of one or more beams selected may be less than or equal to the limited number.

The priorities of beams may be determined based on a measurement result of S-SSBs or measurement result of signals/channels included in the S-SSBs. The signals/channels may be PSSs, SSSs, PSBCHs, and/or PSBCH DMRSs. The measurement result may indicate RSRP, RSRQ, and/or RSSI. For example, a beam through which a high-quality S-SSB or signal/channel is received may be determined to have a high priority, and a beam through which a low-quality S-SSB or signal/channel is received may be determined to have a low priority. The receiving terminal may reconfigure the reception beam set based on the priorities of the beams. For example, the receiving terminal may configure a second reception beam set that includes only beam(s) with high priorities among the beams belonging to the first reception beam set. In other words, beam(s) with low priorities may be excluded from the reception beam set. The receiving terminal may use the second reception beam set instead of the first reception beam set.

The transmitting terminal(s) may perform the following operations according to the PSCCH monitoring period. Within the PSCCH monitoring period, the transmitting terminal(s) may perform repeated PSCCH transmissions. When a HARQ response (e.g., HARQ-acknowledgement (ACK)) for a PSCCH is received from the receiving terminal, the transmitting terminal(s) may stop the repeated PSCCH transmissions. If no HARQ response for the repeated PSCCH transmissions is received from the receiving terminal or if negative ACKs (NACKs) (e.g., consecutive NACKs) for the repeated PSCCH transmissions are received from the receiving terminal, the transmitting terminal(s) may stop the repeated PSCCH transmissions, and the beam pairing operation between the receiving terminal and the transmitting terminal(s) may be performed again. In the beam pairing operation, a synchronization signal may be transmitted and received. The synchronization signal may refer to S-SSB.

The number of repeated PSCCH transmissions and/or the number of NACK receptions (e.g., consecutive NACKs) may be set cell-specifically, UE-specifically, SL-specifically, or RP-specifically. The number of repeated PSCCH transmissions and/or the number of NACK receptions (e.g., consecutive NACKs) may be set to the terminal(s) through signaling. The number of repeated PSCCH transmissions and/or the number of NACK receptions until the repeated PSCCH transmissions are stopped may be set in conjunction with the PSCCH monitoring period. For example, if no HARQ response to the repeated PSCCH transmissions is received from the receiving terminal during two PSCCH monitoring periods or if NACKs (e.g., consecutive NACKs) for the repeated PSCCH transmissions are receiving from the receiving terminal during two PSCCH monitoring periods, the transmitting terminal(s) may stop the repeat PSCCH transmissions.

If no PSCCH is received within a time interval (e.g., PSCCH monitoring resource region) corresponding to specific beam(s) belonging to the reception beam set or if a measurement result of signals/channels received through the specific beam(s) belonging to the reception beam set is less than or equal to a measurement threshold, the receiving terminal may exclude the specific beam(s) from the reception beam set. In other words, the receiving terminal may reconfigure the reception beam set to include beam(s) excluding the specific beam(s). The measurement threshold may be set to the terminal(s) through signaling. The time interval corresponding to the specific beam(s) may be configured by a timer, and the timer may be set independently for each beam (e.g., reception beam). For example, the timers may be set differently for the respective beams. A start time of the time interval corresponding to the specific beam(s) may be a completion time of the beam pairing operation, a time when the specific beam(s) are included in the reception beam set, or a time when the PSCCH monitoring operation for one beam (e.g., specific beam) belonging to the reception beam set is performed first.

An interval corresponding to a time offset may be configured from the start time of the time interval corresponding to the specific beam(s). The time offset and/or time interval may be configured on a slot basis. The time interval (e.g., time interval corresponding to the specific beam(s)) may be configured in conjunction with the PSCCH monitoring period. For example, the time interval may be an interval corresponding to p PSCCH monitoring periods. p may be a natural number. The time interval (e.g., the time interval corresponding to the specific beam(s)) may be configured cell-specifically, UE-specifically, SL-specifically, or RP-specifically. Configuration information of the time interval may be transmitted to the terminal(s) through signaling.

In the synchronization signal reception operation and/or beam pairing operation, the receiving terminal may determine a new reception beam and configure a reception beam set including the new reception beam.

The receiving terminal may have one or more reception beam sets. The number of beams included in each of the reception beam sets may be less than the maximum number. The number (e.g., maximum number) of reception beam sets that the receiving terminal has and/or the number (e.g., maximum number) of beams belonging to the reception beam set may be set cell-specifically, UE-specifically, SL-specifically, or RP-specifically. Configuration information on the number (e.g., maximum number) of reception beam sets that the receiving terminal has and/or the number (e.g., maximum number) of beams belonging to the reception beam set may be transmitted to the terminal(s) through signaling.

The receiving terminal may have two or more reception beam sets. In other words, the receiving terminal may configure two or more reception beam sets (e.g., a first reception beam set and a second reception beam set). The two or more reception beam sets may be configured in the initial access operation. For example, the two or more reception beam sets may be configured based on a measurement result of S-SSBs. Each of two or more reception beam sets may be configured independently. The first reception beam set may include k reception beams, and the second reception beam set may include j reception beams. Each of k and j may be a natural number. k and j may be set to the same value. Alternatively, k and j may be set to different values.

The reception beams belonging to the same reception beam set may have different beam widths. Alternatively, the reception beams belonging to the same reception beam set may have the same beam width. The beam width(s) of the k reception beams included in the first reception beam set may be different from the beam width(s) of the j reception beams included in the second reception beam set. Alternatively, the beam width(s) of the k reception beams included in the first reception beam set may be the same as the beam width(s) of the j reception beams included in the second reception beam set. All the k reception beams included in the first reception beam set may be directional beams. Alternatively, one of the k reception beams included in the first reception beam set may be an omni-beam, and the remaining beam(s) may be directional beam(s). All the j reception beams included in the second reception beam set may be directional beams. Alternatively, one of the j reception beams included in the second reception beam set may be an omni-beam, and the remaining beam(s) may be directional beam(s).

The receiving terminal may perform the PSCCH monitoring operation using reception beam set(s) with a higher priority among two or more reception beam sets. The priority of the reception beam set may be determined based on the number of beams included in the reception beam set, whether the reception beam set includes an omni-beam, and/or a configuration order of the reception beam set. For example, if the number of beams belonging to the first reception beam set is less than the number of beams belonging to the second reception beam set, the priority of the first reception beam set may be determined to be higher than the priority of the second reception beam set. A priority of a reception beam set including an omni-beam may be determined to be higher than a priority of a reception beam set including no omni-beam. A priority of the most recently configured reception beam set may be determined to be higher than that of other reception beam sets. A priority of a reception beam set may be determined based on a combination of the above criteria.

If the PSCCH monitoring operation using the reception beam set with a higher priority fails, the receiving terminal may perform a PSCCH monitoring operation using a reception beam set with the next priority. The receiving terminal may preferentially use a specific reception beam set for synchronization signal monitoring. In other words, the first reception beam set may be preferentially used for synchronization signal monitoring, and the second reception beam set may be preferentially used for PSCCH monitoring. The receiving terminal may exclude a specific beam from a reception beam set for PSCCH monitoring, and the specific beam may be included in another reception beam set.

[Method 3] The receiving terminal may perform a PSCCH monitoring operation using all reception beams (e.g., all reception beams configured in the receiving terminal).

In Method 2, the receiving terminal may select beam(s) to be used for PSCCH monitoring in the initial access operation (e.g., S-SSB reception operation and/or beam pairing operation). In Method 3, the receiving terminal may perform a PSCCH monitoring operation using preconfigured beam(s) or fixed beam(s) during a PSCCH monitoring period regardless of beam-related information obtained in the initial access operation. In the PSCCH monitoring operation, the preconfigured beam(s) or fixed beam(s) may be used sequentially. The reception beam set used in the PSCCH monitoring operation may be equally used in the S-SSB reception operation, beam pairing operation, signaling operation for the beam pairing operation, and/or PSSCH reception operation.

FIG. 11 is a conceptual diagram illustrating a third exemplary embodiment of a PSCCH monitoring operation.

As shown in FIG. 11, three beams (e.g., beam #1, beam #2, and beam #3) with wide beam widths may be configured in a receiving terminal. A beam with a wide beam width may be referred to as a wide beam. A beam with a narrow beam width may be referred to as a narrow beam. The three beams may be configured to allow the receiving terminal to receive signals/channels in the entire angular domain. The receiving terminal may perform a PSCCH monitoring operation using the three beams sequentially. A reception beam set may include the three beams. The receiving terminal may perform an initial access operation (e.g., S-SSB reception operation and/or beam pairing operation) using the reception beam set including the three beams.

Identically or similarly to Method 2, in Method 3, the transmitting terminal(s) may perform the following operations according to a PSCCH monitoring period. Within the PSCCH monitoring period, the transmitting terminal(s) may perform repeated PSCCH transmissions. When a HARQ response (e.g., HARQ-ACK) for a PSCCH is received from the receiving terminal, the transmitting terminal(s) may stop the repeated PSCCH transmissions. If no HARQ response for the repeated PSCCH transmissions is received from the receiving terminal or if NACKs (e.g., consecutive NACKs) for the repeated PSCCH transmissions are received from the receiving terminal, the transmitting terminal(s) may step the repeated PSCCH transmissions, and may perform a beam pairing operation between the receiving terminal and the transmitting terminal(s) again. In the beam pairing operation, synchronization signals may be transmitted and received.

The number of repeated PSCCH transmissions and/or the number of NACK receptions (e.g., consecutive NACKs) may be set cell-specifically, UE-specifically, SL-specifically, or RP-specifically. The number of repeated PSCCH transmissions and/or the number of NACK receptions (e.g., consecutive NACKs) may be set to the terminal(s) through signaling. The number of repeated PSCCH transmissions and/or the number of NACK receptions until the repeated PSCCH transmissions are stopped may be set in conjunction with the PSCCH monitoring period.

The receiving terminal may have one or more reception beam sets. The number of beams included in each of the reception beam sets may be less than the maximum number. The number (e.g., maximum number) of reception beam sets that the receiving terminal has and/or the number (e.g., maximum number) of beams belonging to the reception beam set may be set cell-specifically, UE-specifically, SL-specifically, or RP-specifically. Configuration information on the number (e.g., maximum number) of reception beam sets that the receiving terminal has and/or the number (e.g., maximum number) of beams belonging to the reception beam set may be transmitted to the terminal(s) through signaling.

If no PSCCH is received through the first reception beam set within a predefined time interval (e.g., PSCCH monitoring resource region) or if a measurement result of signals/channels received through the first reception beam set is less than or equal to a measurement threshold, the receiving terminal may perform a PSCCH monitoring operation using the second reception beam set instead of the first reception beam set. The measurement threshold may be set to the terminal(s) through signaling. When measurement operations for a plurality of signals/channels are performed, the receiving terminal may decide whether to use another reception beam set based on an average value of results of the measurement operations or the lowest value among the results of the measurement operations.

A start time of the predefined time interval may be a completion time of the beam pairing operation, a time when a specific beam is included in the reception beam set, or a time when a PSCCH monitoring using one beam (e.g., specific beam) belonging to the reception beam set is performed first. An interval corresponding to a time offset from the start time of the predefined time interval may be configured. The time offset and/or time interval may be configured on a slot basis. The time interval (e.g., predefined time interval) may be configured in conjunction with the PSCCH monitoring period. For example, the time interval may be an interval corresponding to p PSCCH monitoring periods. p may be a natural number. The time interval (e.g., predefined time interval) may be configured cell-specifically, UE-specifically, SL-specifically, or RP-specifically. Configuration information of the time interval may be transmitted to the terminal(s) through signaling.

A plurality of reception beam sets may be configured. The plurality of reception beam sets may be configured cell-specifically, UE-specifically, SL-specifically, or RP-specifically. Configuration information of the plurality of reception beam sets may be transmitted to the terminal(s) through signaling. For example, the transmitting terminal may transmit a PSCCH (e.g., SCI) including configuration information of the plurality of reception beam sets to the receiving terminal. The configuration information of the plurality of reception beam sets may include an index (e.g., indication bit(s)) of each of the plurality of reception beam sets and/or the number of beams (e.g., reception beams) belonging to each of the plurality of reception beam sets. For example, the configuration information of the plurality of reception beam sets may be configured as shown in Table 3 below. In Table 3, the number of reception beams may refer to the maximum number of reception beams. In this case, the receiving terminal may configure a reception beam set including no more than the maximum number of beams.

TABLE 3

| Indication bit(s) | Reception beam set | Number of reception beams |
|---|---|---|
| 00 | Reception beam set #1 | 3 |
| 01 | Reception beam set #2 | 6 |
| 10 | Reception beam set #3 | 9 |
| 11 | Reception beam set #4 | 12 |

When the resource allocation (RA) mode 1 is used in SL communication, the base station may control SL communication. For example, the base station may allocate resources for SL communication to the terminal(s). In this case, the base station may transmit the indication bit(s) in Table 3 to the terminal. The base station may transmit the indication bit(s) to the transmitting terminal through signaling on a Uu link. The transmitting terminal may receive the indication bit(s) from the base station, and transmit the indication bit(s) to the receiving terminal through signaling on a PC5 link. The receiving terminal may receive the indication bit(s) from the transmitting terminal. For example, if the indication bit(s) transmitted by the base station are set to ‘01’, the terminal (e.g., receiving terminal) may configure a reception beam set #2 including up to 6 beams. Additionally, the terminal may configure a plurality of reception beam sets based on indications from the base station.

When the RA mode 2 is used in SL communication, the transmitting terminal may transmit indication bit(s) in Table 3 to the receiving terminal, and the receiving terminal may configure a reception beam set based on the indication bit(s) received from the transmitting terminal.

The receiving terminal may perform a PSCCH monitoring operation using the reception beam set #1 of Table 3. If no PSCCH is received through the reception beam set #1 within a predefined time interval or if a measurement result of signals/channels received through the reception beam set #1 is equal to or less than a measurement threshold, the receiving terminal may perform a PSCCH monitoring operation using the reception beam set #2 instead of the reception beam set #1. In other words, the reception beam set used by the receiving terminal may be changed from the reception beam set #1 to the reception beam set #2.

The beam widths of the beams belonging to the reception beam sets in Table 3 may be different. For example, the beam widths may decrease in an order of ‘reception beam set #1→reception beam set #2→reception beam set #3→reception beam set #4’. In other words, the beam width of the beam belonging to the reception beam set #1 may be the widest, and the beam width of the beam belonging to the reception beam set #4 may be the narrowest. When the reception beam set used by the receiving terminal changes from the reception beam set #1 to the reception beam set #2, PSCCH reception performance can be improved because a gain of the reception beam increases.

When the number of beams used for PSCCH monitoring is large, the PSCCH monitoring operation may be performed sequentially using the beams, so a delay problem in the PSCCH monitoring operation may occur. If a measurement result of signals/channels received through the reception beam set exceeds the measurement threshold, the receiving terminal may perform a PSCCH monitoring operation using another reception beam set including a smaller number of beams than the currently-used reception beam set. For example, if a measurement result of signals/channels received through the second reception beam set exceeds the measurement threshold, the receiving terminal may change the reception beam set used by the receiving terminal from the second reception beam set to the first reception beam set, and may perform a PSCCH monitoring operation using the first reception beam set.

[Method 4] Combination of Method 1, Method 2, and/or Method 3

### Combination of Methods 1, 2, and 3

In Method 2 and/or Method 3, the reception beam set may include an omni-beam. In this case, the receiving terminal may perform a PSCCH monitoring operation using the omni-beam in a predefined resource region. For example, one of the reception beams belonging to the reception beam set defined in Table 3 may be an omni-beam. Within one PSCCH monitoring period, the transmitting terminal may transmit a PSCCH in each of a first interval corresponding to a reception beam (e.g., directional beam of the receiving terminal) paired with a transmission beam of the transmitting terminal and a second interval corresponding to the omni-beam of the receiving terminal. In this case, the PSCCH may be transmitted twice within one PSCCH monitoring period. According to the above operation, a reception probability of the PSCCH can be increased. The first interval may be located before the second interval in the time domain. Alternatively, the second interval may be located before the first interval in the time domain.

In a combination of Methods, one reception beam set may include only one beam, and the one beam may be configured as an omni-beam.

### Combination of Methods 2 and 3

Configurations of a reception beam set for PSCCH monitoring may be different in Methods 2 and 3. In Method 2, the reception beam set may be configured to include reception beam(s) determined in the S-SSB reception operation. In Method 3, the reception beam set may be configured to include all available reception beams for PSCCH monitoring. In Method 3, the receiving terminal may perform the PSCCH monitoring operation using all the reception beams sequentially. As the number of reception beams belonging to the reception beam set decreases, a latency for the PSCCH monitoring operation may be reduced, and PSCCH monitoring operations for many transmitting terminals may be performed within predefined time-frequency resources. As the number of reception beams belonging to the reception beam set decreases, a beam width of each of the reception beams may become wider, a gain of the reception beams may decrease, a quality of SL communication may deteriorate, and a coverage of SL communication may be reduced. Considering the above problem, it may be efficient for the receiving terminal to perform the PSCCH monitoring operation based on Method 2.

A combination of Methods 2 and 3 may operate based on the criteria below. The receiving terminal may configure two or more reception beam sets for Methods 2 and 3 by performing the S-SSB reception operation. In an SL data reception operation, if a measurement result of signals/channels received through the first reception beam set is less than or equal to a measurement threshold, the receiving terminal may change the reception beam set used by the receiving terminal from the first reception beam set to the second reception beam set, and may perform a reception operation of SL data using the second reception beam set. The reception operation of the SL data may include a PSCCH reception operation and/or a PSSCH reception operation. The measurement result may indicate RSRP, RSRQ, and/or RSSI. The measurement result may be a measurement result of a PSCCH, PSSCH, PSCCH DMRS, and/or PSSCH DMRS. The PSCCH DMRS may be a DMRS used for demodulation of the PSCCH. The PSSCH DMRS may be a DMRS used for demodulation of the PSSCH. The measurement threshold may be set to the terminal(s) through signaling.

One RSRP threshold may be used and/or set. If the lowest RSRP value among RSRP values measured for a plurality of signals/channels exceeds the RSRP threshold, the receiving terminal may change the reception beam set based on Method 3, and perform communication using the changed reception beam set. If the lowest RSRP value among the RSRP values measured for the plurality of signals/channels is equal to or less than the RSRP threshold, the receiving terminal may change the reception beam set based on Method 2, and perform communication using the changed reception beam set.

A plurality of thresholds for changing the reception beam set may be used and/or set. Base on a result of comparison between the threshold(s) and one of the following: an average of the RSRP values measured for the plurality of signals/channels, the lowest RSRP value among the measured RSRP values, or the largest RSRP value among the measured RSRP values, the receiving terminal may change the reception beam set and perform communication using the changed reception beam set.

The above-described PSCCH monitoring operation may be configured cell-specifically, UE-specifically, SL-specifically, or RP-specifically.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), comprising:
receiving one or more sidelink-synchronization signal blocks (S-SSBs) from a second UE using a plurality of beams;
determining two or more beams used in sidelink (SL) communication between the first UE and the second UE based on a measurement result of the one or more S-SSBs; and
performing a first physical sidelink control channel (PSCCH) monitoring operation for the second UE using an omni-beam among the two or more beams,
wherein the two or more beams belong to the plurality of beams.

2. The method of claim 1, further comprising: in response to a failure of the first PSCCH monitoring operation, performing a second PSCCH monitoring operation for the second UE using a directional beam among the two or more beams.

3. The method of claim 1, wherein when the measurement result is greater than or equal to a measurement threshold, the first PSCCH monitoring operation is performed preferentially using the omni-beam.

4. The method of claim 1, wherein when a distance between a first location of the first UE and a second location of the second UE is within a reference distance, the first PSCCH monitoring operation is performed preferentially using the omni-beam.

5. The method of claim 4, wherein information on the second location of the second UE is received from the second UE, and information on the reference distance is received from at least one of the second UE or a base station.

6. A method of a first user equipment (UE), comprising:
performing an initial access operation with one or more second UEs to determine a plurality of reception beams for the first UE;
configuring a first reception beam set including the plurality of reception beams; and
performing a first physical sidelink control channel (PSCCH) monitoring operation for the one or more second UEs using one or more reception beams belonging to the first reception beam set.

7. The method of claim 6, wherein when the one or more reception beams are a plurality of reception beams, the first PSCCH monitoring operation is performed using the plurality of reception beams sequentially.

8. The method of claim 6, wherein when the one or more reception beams include a first reception beam and a second reception beam, and a number of second UEs having beams paired with the first reception beam is greater than a number of second UEs having beams paired with the second reception beam, a number of times the first PSCCH monitoring operation using the first reception beam is performed is greater than a number of times the first PSCCH monitoring operation using the second reception beam is performed.

9. The method of claim 6, wherein a maximum number of reception beams used for the first PSCCH monitoring operation within one PSCCH monitoring period is set to the first UE through signaling, and a number of the one or more reception beams is less than or equal to the maximum number.

10. The method of claim 6, wherein when a maximum number of reception beams used for the first PSCCH monitoring operation within one PSCCH monitoring period is set to the first UE through signaling, and a number of the plurality of reception beams included in the first reception beam set exceeds the maximum number, the first PSCCH monitoring operation is performed using the one or more reception beams with higher priority among the plurality of reception beams.

11. The method of claim 10, further comprising: configuring a second reception beam set including the one or more reception beams with a higher priority,
wherein the first PSCCH monitoring operation is performed using the second reception beam set instead of the first reception beam set.

12. The method of claim 10, wherein priorities of the plurality of reception beams included in the first reception beam set are determined based on a measurement result of sidelink-synchronization signal blocks (S-SSBs) received in the initial access operation.

13. The method of claim 6, further comprising: in response to no PSCCH being received in the first PSCCH monitoring operation, reconfiguring the first reception beam set including at least one reception beam excluding the one or more reception beams from the plurality of reception beams.

14. A method of a first user equipment (UE), comprising:
configuring a first reception beam set;
configuring a second reception beam set; and
performing a first physical sidelink control channel (PSCCH) monitoring operation using one reception beam set with a higher priority among the first reception beam set and the second reception beam set,
wherein each of the first reception beam set and the second reception beam set includes one or more reception beams.

15. The method of claim 14, further comprising: in response to a failure of the first PSCCH monitoring operation, performing a second PSCCH monitoring operation using another reception beam set with a lower priority than the one reception beam set among the first reception beam set and the second reception beam set.

16. The method of claim 14, further comprising: in response to a number of beams included in the first reception beam set being less than a number of beams included in the second reception beam set, determining the first reception beam set as the one reception beam set with a higher priority.

17. The method of claim 14, further comprising: in response to the first reception beam set including an omni-beam and the second reception beam set including no omni-beam, determining the first reception beam set as the one reception beam set with a higher priority.

18. The method of claim 14, further comprising: in response to the second reception beam set being configured more recently than the first reception beam set, determining the second reception beam set as the one reception beam set with a higher priority.
